(19) United States
(12) Patent Application Publication
(10) Pub. No.: US 2023/0256967 A1
(43) Pub. Date: Aug. 17, 2023

(54) APPARATUS FOR CONTROLLING VEHICLE, METHOD FOR CONTROLLING VEHICLE AND CONTROL PROGRAM THEREOF

(71) Applicants: DENSO CORPORATION, Kariya-city (JP); TOYOTA JIDOSHA KABUSHIKI KAISHA, Toyota-shi (JP)

(72) Inventors: Suguru SAKAI, Tokyo (JP); Masumi FUKUMAN, Tokyo (JP); Yasutaka ATARASHI, Tokyo (JP); Yasuo OKUDA, Tokyo (JP); Yuuichirou KOGA, Tokyo (JP); Takuya KAMINADE, Okazaki-shi (JP); Masashi OISHI, Owariasahi-shi (JP); Masaki IKAI, Toyota-shi (JP)

(21) Appl. No.: 18/306,796

(22) Filed: Apr. 25, 2023

(30) Foreign Application Priority Data
Apr. 27, 2022 (JP) 2022-073580

(51) Int. Cl. B60W 30/14; B60W 40/12; B60W 40/02

(52) U.S. Cl. CPC B60W 30/146; B60W 40/12; B60W 40/02; B60W 2530/00; B60W 2554/80

(57) ABSTRACT

A vehicle control apparatus is provided with a reliability determination unit that determines a reliability related to an own vehicle location as a current location of the own vehicle being in a parking place, using a detection result of a parking space or a parked vehicle around an own vehicle based on image data around the own vehicle captured by a camera; and an own vehicle location determination unit that determines whether the own vehicle location is in the parking place, using a determination result of the reliability determined by the reliability determination unit.

### CROSS-REFERENCE TO RELATED APPLICATION

This application is based on and claims the benefit of priority from earlier Japanese Patent Application No. 2022-073580 filed Apr. 27, 2022, the description of which is incorporated herein by reference.

### BACKGROUND

### Technical Field

The present disclosure relates to an apparatus for controlling vehicle, a method and program for controlling vehicle.

### Description of the Related Art

In recent years, various control apparatuses for controlling vehicles have been developed. As an example, a technique for determining whether an own vehicle is in a parking space is required. In the case where a driver erroneously presses an acceleration pedal instead of pressing a brake pedal when braking operation is required, the vehicle accelerates against the driver's intention. This causes a dangerous situation especially in a parking space. In this respect, in order to avoid a rapid acceleration of the vehicle caused by such a driver's erroneous operation (erroneously pressing the accelerator pedal), a determination of whether an own vehicle is in a parking space may be required.

### SUMMARY

The present disclosure provides a vehicle control apparatus including: a reliability determination unit that determines a reliability related to an own vehicle location as a current location of the own vehicle being in a parking place, using a detection result of a parking space or a parked vehicle around an own vehicle based on image data around the own vehicle captured by a camera; and an own vehicle location determination unit that determines whether the own vehicle location is in the parking space, using a determination result of the reliability determined by the reliability determination unit.

### BRIEF DESCRIPTION OF THE DRAWINGS

In the accompanying drawings:

FIG. 1 is a plan view showing an overall configuration of an own vehicle on which an on-vehicle system including a vehicle control apparatus according to an embodiment of the present disclosure is installed;

FIG. 2 is a block diagram showing an overall configuration of an on-vehicle system shown in FIG. 1;

FIG. 3 is a block diagram showing an overall configuration accomplished by the vehicle control apparatus shown in FIG. 2;

FIG. 4 is a plan view showing a plan view showing an overview of an operation performed by the vehicle control apparatus shown in FIG. 2;

FIG. 5 is a plan view showing a plan view showing an overview of an operation performed by the vehicle control apparatus shown in FIG. 2;

FIG. 6 is a plan view showing a plan view showing an overview of an operation performed by the vehicle control apparatus shown in FIG. 2;

FIG. 7 is a plan view showing a plan view showing an overview of an operation performed by the vehicle control apparatus shown in FIG. 2;

FIG. 8 is a plan view showing a plan view showing an overview of an operation performed by the vehicle control apparatus shown in FIG. 2; and

FIG. 9 is a plan view showing a plan view showing an overview of an operation performed by the vehicle control apparatus shown in FIG. 2.

### DETAILED DESCRIPTION OF THE PREFERRED EMBODIMENTS

In recent years, various control apparatuses for controlling vehicles have been developed. As an example, a technique for determining whether an own vehicle is in a parking space is required. In the case where a driver erroneously presses an acceleration pedal instead of pressing a brake pedal when braking operation is required, the vehicle accelerates against the driver's intention. This causes a dangerous situation especially in a parking space. In this respect, in order to avoid a rapid acceleration of the vehicle caused by such a driver's erroneous operation (erroneously pressing the accelerator pedal), a determination of whether an own vehicle is in a parking space may be required.

In this respect, a patent literature, JP-A-2015-64795 discloses a technique for improving an accuracy for determining whether an own vehicle is in a parking space. According to a parking space determination apparatus of the above patent literature, a bird's eye view image based on an image captured by a camera is generated, and it is determined whether the own vehicle is in a parking space based on whether a parking frame and a parked vehicle is present.

For controlling the vehicle, the above control, that is, improving the accuracy for determining whether the current location of the own vehicle is in a parking space is very useful.

### EMBODIMENTS

Hereinafter, with reference to the drawings, embodiments of the present disclosure will be described. For various modification examples applicable to one embodiment, if they are inserted into description of the embodiments, understanding of the embodiments may be disturbed. Hence, the modification examples are described in the end of the embodiments.

(Configuration of On-Vehicle System)

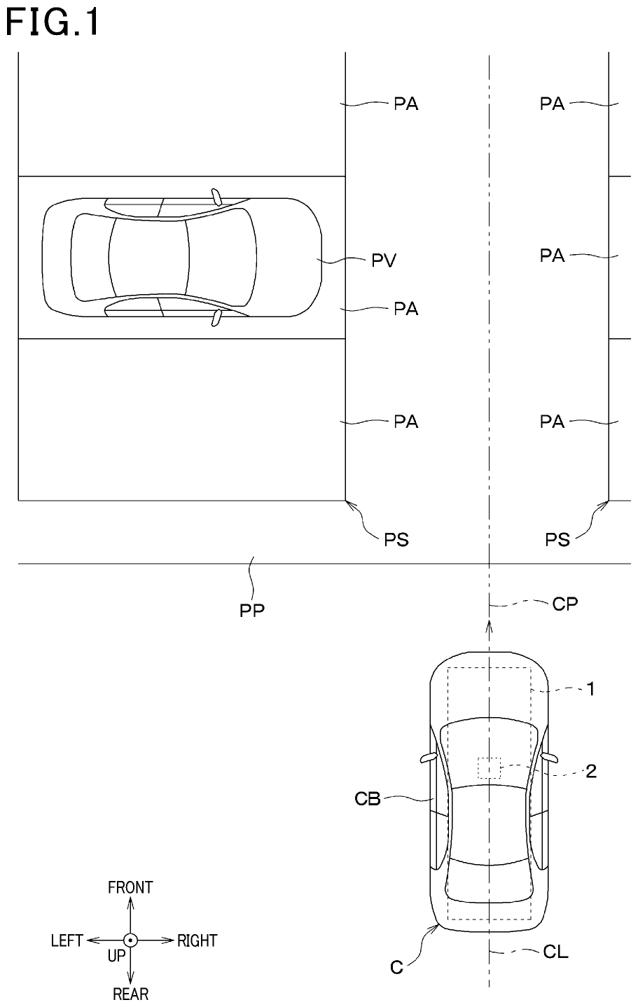

Referring to FIG. 1, an on-vehicle system 1 is installed on an own vehicle C as a moving body. According to the present embodiment, the own vehicle C is a so-called four-wheel vehicle provided with a box-shaped vehicle body CB formed in a substantially rectangular shape in plan view. A shape of each portion in the own vehicle C in plan view is referred to a shape of portion when viewed from the same direction as a gravity direction in a state where the vehicle is set to be capable of travelling and stably placed on a horizontal plane.

Hereinafter, a virtual straight line passing through the center of the vehicle width direction of the own vehicle C and being parallel to a vehicle longitudinal direction of the own vehicle C in plan view is referred to as a vehicle width center line CL. Note that the vehicle width center line is also referred to as a vehicle center line. In the drawing, the vehicle width center line CL is indicated by an arrow so as to indicate a travelling direction of the own vehicle C when the own vehicle C is travelling forward. Note that ‘traveling forward’ refers to a state where the travelling speed of the own vehicle C is 0 or higher, and a shift position is being set to be forward (i.e. travelling position other than reverse position). The travelling position refers to a position other than a parking position and a neutral position. The vehicle longitudinal direction is a direction orthogonal to the vehicle width direction and orthogonal to the vehicle height direction. The vehicle height direction refers to a direction defining a vehicle height of the own vehicle C and a direction parallel to the gravity direction in a state where the vehicle is set to be capable of travelling and stably placed on a horizontal plane. Moreover, front, rear, left, right and up directions are defined as similar to directions indicated by the arrow shown in FIG. 1. The vehicle longitudinal direction is the same as longitudinal direction. The vehicle width direction is the same as left-right direction. Moreover, a scheduled travelling path of the own vehicle is indicated by a two-dot chain line as a predicted course CP in the drawing.

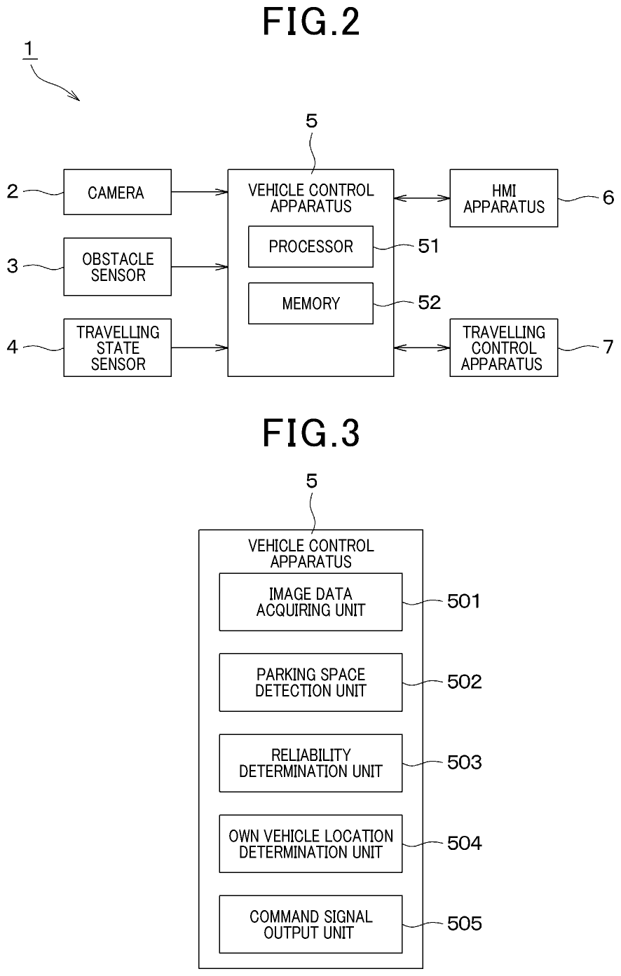

The on-vehicle system 1 is configured to detect objects around the own vehicle C using a camera 2 and an obstacle sensor 3, execute a behavior control (e.g. suppression of sudden start caused by erroneous pedal pressing) of the own vehicle C based on the detected object and information notification to the passengers. More specifically, the on-vehicle system 1 has a configuration that determines whether the location of the own vehicle (also referred to as own vehicle location) is in a parking place PP in accordance with a detection result of a parking space PS or a parked vehicle PV around the own vehicle C or a parked vehicle PV based on captured image around the own vehicle C using the camera 2. The own vehicle location is a current location of the own vehicle C. The parking space PS is defined as a parking area PA for parking one ordinary motor vehicle, or parking area PA where the parked vehicle PV being parked in the parking space PV are consecutively arranged in the same direction for a predetermined number (e.g. 2 or more). The parking area PA is not limited to one sectioned by a mark line on the road. The on-vehicle system 1 is configured to execute a vehicle behavior control depending on a result of determination whether the own vehicle location is in the parking place PP. Specifically, as shown in FIG. 2, the on-vehicle system 1 is provided with the camera 2, the obstacle sensor 3 and a travelling state sensor 4, a vehicle control apparatus 5, an HMI apparatus 6 and a travelling control apparatus 7. HMI is an abbreviation of human machine interface.

The camera 2 is provided so as to capture an image around the own vehicle C. According to the present embodiment, the camera 2 is a so-called a front camera provided to capture an image in a front area and a front side area of the own vehicle C. The camera 2 is connected to the vehicle control apparatus 5 via an on-vehicle communication line to be capable of performing information communication or a signal communication therebetween, whereby the image data as an image capturing result is transmitted to the vehicle control apparatus 5.

The obstacle sensor 3 is provided to detect an obstacle existing around the own vehicle C. The own vehicle C includes, as the obstacle sensor 3, at least one of a radar sensor, a laser radar sensor and an ultrasonic wave sensor. The obstacle sensor 3 is connected to the vehicle control apparatus 5 via an on-vehicle communication line to be capable of performing information communication or a signal communication therebetween, whereby the detection result of the obstacle around the own vehicle C is transmitted to the vehicle control apparatus 5.

The travelling state sensor 4 is provided to detect various types of parameters related to the travelling state of the own vehicle C. The ‘various types of parameters related to the travelling state’ includes parameters related to a driving operation state by the driver or an automatic driving system, such as an accelerator operation quantity, a braking operation quantity, a shift position, and a steering angle. Further, the ‘various types of parameters related to the travelling state’ includes physical quantities related to a behavior of the own vehicle C such as a travelling speed, an angular velocity, an acceleration in the longitudinal direction, and an acceleration in the left-right direction. That is, the travelling state sensor 4 is a collective word of the known sensors required for vehicle driving control such as an acceleration opening sensor, a steering angle sensor, a wheel speed sensor, an angular velocity sensor, an acceleration sensor and a yaw rate sensor, in order to simplify the illustration and explanation. The travelling state sensor 4 is connected to the vehicle control apparatus 5 via an on-vehicle communication line to be capable of performing information communication or a signal communication therebetween, whereby the detection result of the travelling state is transmitted to the vehicle control apparatus 5.

The vehicle control apparatus 5 is accommodated inside the vehicle body CB. The vehicle control apparatus 5 is configured to control operations of respective portions of the own vehicle C including the HMI apparatus 6 or the travelling control apparatus 7. According to the present embodiment, the vehicle control apparatus 5 is configured as an on-vehicle computer provided with a processor 51 and a memory 52. The processor 51 is configured of a CPU and MPU. The memory 52 is provided with at least ROM and RAM among various non-transitory tangible recording medium such as ROM, RAM and non-volatile rewritable memory. The non-volatile rewritable memory is a memory unit in which information is rewritable while powered-ON while the information cannot be written during powered-OFF. For example, the non-volatile rewritable memory is configured as a flash ROM. The vehicle control apparatus 5 is configured to read the control program stored in the ROM or non-volatile rewritable memory and execute the control program, thereby controlling the whole on-vehicle system 1.

The HMI apparatus 6 is configured of a display apparatus or a speaker and the like for providing various information or alert to the passengers in the own vehicle C. The traveling control apparatus 7 is provided to execute a motion control in the longitudinal direction and/or the lateral direction of the own vehicle C. Specifically, the travelling control apparatus 7 is configured to execute at least part of the motion control in the own vehicle C such as starting, acceleration/deceleration, braking, stopping, steering and the like.

(Vehicle Control Apparatus)

FIG. 3 illustrates a part of functional configuration accomplished on an on-vehicle microcomputer. For the functional configuration, the processor 51 reads a vehicle control program from the memory 52 to execute the vehicle program, thereby accomplishing the functional configuration. As shown in FIG. 3, the vehicle control apparatus 5 is provided with, as a functional configuration accomplished on the on-vehicle microcomputer, an image data acquiring unit 501, a parking space detection unit 502, a reliability determination unit 503, an own vehicle location determination unit 504 and a command signal outputting unit. Hereinafter, with reference to FIGS. 1 to 3, detailed configuration of the vehicle control apparatus 5 will be described.

The image data acquiring unit 501 acquires image data from the camera 2. The parking space detection unit 502 is configured to detect a parking space PS and a parked vehicle PV with a known image recognition method based on the image data acquired by the image data acquiring unit 501. Hereinafter, the parking space PS and the parked vehicle PV are generically named as ‘parking space PS or the like’ when they are not discerned. Similarly, the parking area PA and the parked vehicle PV are generically named as ‘parking area PA or the like)

The reliability determination unit 503 is configured to determine, based on a detection result of the parking space PS around the own vehicle C, a reliability related to the own vehicle location being in the parking place PP. Note that ‘reliability related to the own vehicle location being in the parking place PP’ is hereinafter referred to as ‘own vehicle location reliability’. Specifically, the reliability determination unit 503 is configured to determine the own vehicle location reliability, based on a detection reliability of a detected parking space PS or the like which is determined in accordance with a continuity of the parking area PA, a detection state of the parking area PA and the like. The continuity of the parking area PA includes, for example, a determination whether the parking area PA and/or the parked vehicle PV are continuously detected in the same direction for a predetermined number of times or more. The detection state of the parking area PA and the like includes, for example, a reliability for recognizing a white line on the road that constitutes the parking area PA. Also, in the present embodiment, the reliability determination unit 503 is configured to determine, based in a relative location of the detected parking space PS relative to the own vehicle C, the own vehicle location reliability. The relative location includes a distance from the own vehicle C and a position relationship with the own vehicle C. The positional relationship includes, for example, a determination whether the parking space PS or the like is detected only at a right side of the own vehicle C, or detected only at a left side of the own vehicle C, or detected at both left and right sides of the own vehicle C, or detected in front of the own vehicle C.

According to the present embodiment, the reliability determination unit 503 is configured to determine the own vehicle location reliability with a multi-stage level such as three or more levels. More specifically, the reliability determination unit 503 determines the own vehicle location reliability as follows. In the following description, reliability 2 corresponds to high reliability, reliability 1 corresponds to low reliability and the higher the value, the higher the own vehicle location reliability is. In other words, higher value indicates high probability of the own vehicle location being in the parking place PP.
Reliability 2: parking space PS is detected with a high reliability in a predetermined distance in both left and right sides or detected in a predetermined distance in the front side.
Reliability 1: parking space PS is detected with an intermediate reliability in a predetermined distance in both left and right sides or detected in a predetermined distance in the front side.
Reliability 1: parking space PS is detected with intermediate to high reliability in a predetermined distance only in the left side or the right side.
Reliability 0: other than above.

The own vehicle location determination unit 504 is configured to determine whether the own vehicle location is in the parking place PP based on a result of determination of the own vehicle location reliability determined by the reliability determination unit 503. Further, according to the present embodiment, the own vehicle location determination unit 504, when being determined that the own vehicle location is not in the parking place PP (negative determination), maintains this negative determination even if the own vehicle location reliability increases, while a predetermined negative determination maintaining condition is being satisfied. Note that the negative determination maintaining condition is lower than or equal to a predetermined level (i.e. reliability 1 in the above described example). Specifically, in order to avoid erroneous detection, the own vehicle location determination unit 504 does not determine that the own vehicle location is in the parking place PP when the reliability is lower than a certain reliability, even when the own vehicle location reliability increases from a state where the parking space PS or the like is not detected. Also, the own vehicle location determination unit 504, when determined that the own vehicle location is in the parking place PP (affirmative determination), maintains this affirmative determination even if the own vehicle location reliability decreases, while a predetermined affirmative determination maintaining condition is being satisfied. Note that the affirmative determination maintaining condition is a travel distance or an elapsed time. That is, in order to avoid mis-determination during the travelling in the parking space PP, the own vehicle location determination unit 504 maintains the determination in which own vehicle location is in the parking place PP, during a certain travel distance or a certain elapsed time, even when the own vehicle location reliability decreases from high reliability state. Specifically, the own vehicle location determination unit 504 is configured to execute the determination process as follows.
Reliability 2: determination whether the own vehicle location is in the parking place PP is satisfied (affirmative determination)
Reliability 1: determination whether the own vehicle location is in the parking place PP is not satisfied (negative determination)/however, in the case where the reliability is decreased from reliability 2, the determination that the own vehicle is in the parking space PP is maintained while the travelling distance (e.g. several tens of meters) or a travelling time (e.g. around 10 seconds) from a time when the reliability decreases to reliability 2 is within a predetermined range.
Reliability 0: determination whether the own vehicle location is in the parking place PP is not satisfied (negative determination)/however, in the case where the reliability is decreased from reliability 1 or 2 when the determination whether the own vehicle location is in the parking place PP is satisfied, the determination that the own vehicle is in the parking space PP is maintained while the travelling distance (e.g. several meters) or a travelling time (e.g. around several seconds) from a time when the reliability decreases to reliability 2 is within a predetermined range.

The command signal output unit 505 generates, based on the determination result of the own vehicle location determination unit 504, a command signal for controlling the operation of the HMI apparatus 6 or the travelling control apparatus 7, and outputs the generated command signal to the HMI apparatus 6 or the travelling control apparatus 7. In other words, the HMI apparatus 6 is provided to display a state related to whether the current location of the own vehicle C is in the parking place PP or perform a voice guidance in accordance with the command signal received from the command signal output unit 505. Further, the travelling control apparatus 7 executes, based on the command signal received from the command signal output unit 505, a motion control of the own vehicle C depending on whether the current location of the own vehicle C is in the parking place PP.

(Overall Operation)

Hereinafter, overall operation of the vehicle control apparatus 5, and overall operation of the vehicle control method and the vehicle control program according to the present embodiment together with effects and advantages obtained therefrom will be described with reference to the drawings. In the following description, the vehicle control apparatus 5, the vehicle control method and the vehicle control program executed by the vehicle control apparatus 5 may be generically referred to present embodiment.

The image data acquiring unit 501 acquires image data from the camera 2 as a capturing result of an image around the own vehicle C. The parking space detection unit 502 detects, based on the image data acquired by the image data acquiring unit 501, the parking space PS or the like with a known image recognition method. The own vehicle location determination unit 504b determines, based on the detection result of the parking space PS or the like, whether the own vehicle location is in the parking place. The command signal output unit 505 generates, based on the determination result of the own vehicle location determination unit 504, a command signal for controlling the operation of the HMI apparatus 6 or the travelling control apparatus 7, and outputs the generated command signal to the HMI apparatus 6 or the travelling control apparatus 7. Thus, in the case where the own vehicle C travels in the parking place PP where the travelling speed is limited, the travelling mode is set to be a parking space mode, whereby a rapid acceleration in the parking place PP can be reliably restricted. Alternatively, a sudden start suppression function when the driver of the own vehicle C erroneously presses the accelerator pedal in the parking place PP can be switched between enabled and disabled depending on the determination whether the current location of the own vehicle C is in the parking place PP.

Here, an accuracy for a recognizing the parking space PS and an accuracy for determining the own vehicle location based on the recognition result may be deteriorated. Specifically, for example, according to the conventional art, even in the case where the parking space PS is favorably detected in a part of the parking place PP and it is determined that the own vehicle C is travelling in the parking place PP, the own vehicle C may not be determined as being travelling in the parking place PP depending on later travelling state in the parking place PP. Further, when the own vehicle C detects a parking area PA at a road side of the travelling road and an intersection, it may erroneously determine that the own vehicle is travelling in the parking place PP. Further, in the case where an obstacle such as a columella or a pedestrian are present between adjacent parking areas PA or the like, the parking areas PA or the like may be discontinuously detected. Hence, the parking areas PA may not be determined to be in the same parking place PP.

In this respect, according to the present embodiment, the own vehicle location reliability is determined in accordance with a detection result such as a parking space PS around the own vehicle based on the image data. That is, according to the present embodiment, the own vehicle location reliability is determined based on the relative location of the detected parking space PS relative to the own vehicle C. More specifically, according to the present embodiment, the own vehicle location reliability is determined based on a continuity or detection state of the detected parking space PS or the like, using a multi-stage level determination such as three or more levels. Specifically, for example, according to the present embodiment, the own vehicle location reliability is determined to be a reliability 2 in the case where the parking space PS is detected with a high reliability in a predetermined distance in both left and right sides of the own vehicle C or detected in a predetermined distance in the front side of the own vehicle C. Also, according to the present embodiment, the own vehicle location reliability is determined to be a reliability 1 in the case where the parking space PS is detected with an intermediate reliability in a predetermined distance in both left and right sides of the own vehicle C or detected in a predetermined distance in the front side of the own vehicle C. Furthermore, according to the present embodiment, the own vehicle location reliability is determined to be a reliability 1 in the case where the parking space PS is detected with an intermediate to high reliability in either one side in the left and right sides of the own vehicle C. Otherwise, the own vehicle location reliability is determined to be a reliability 0 according to the present embodiment. The detection reliability of the parking space PS or the like is a reliability for recognizing the white line on the road and for detecting objects on the road. For example, the detection reliability may be determined with a state of recognizing the white line depending on blur of the white marking, weather and the like, a shape and size of an area surrounded by the white line. According to the present embodiment, the on-vehicle system 1 determines whether the own vehicle location is in the parking place PP based on a determination result of the above-described own vehicle location reliability.

Further, in order to avoid erroneous detection, the system according to the present embodiment, when being determined that the own vehicle location is not in the parking place PP (negative determination), maintains this negative determination even if the own vehicle location reliability increases, while a predetermined negative determination maintaining condition is being satisfied. In other words, according to the present embodiment, even when the own vehicle location reliability increases from a state where the parking space PS or the like is not detected, the system does not determine that the own vehicle location is in the parking place PP when the reliability is less than or equal to a certain reliability (i.e. reliability 1). Further, according to the present embodiment, in order to avoid mis-determination during the travelling in the parking place PP, the system maintains an affirmative determination even when the own vehicle location reliability decreases while a predetermined affirmative determination maintaining condition is being satisfied. That is, according to the present embodiment, even when the own vehicle reliability decreases from the high reliability, the system maintains the determination in which the own vehicle C is travelling in the parking place PP during a certain travel distance or a certain elapsed time. More specifically, according to the present embodiment, when determined that the own vehicle location reliability is determined as 2, the system immediately determine that the current location of the own vehicle C is in the parking place PP. This is because, the own vehicle location reliability cannot be 2 while the own vehicle C is travelling outside the parking place PP. Also, according to the present embodiment, even when the own vehicle location reliability increases to reliability 1 from reliability 0, the system does not determine that the current location of the own vehicle C is in the parking place PP. This is because, the own vehicle location reliability can be 1 while the own vehicle C is travelling outside the parking place PP. On the other hand, according to the present embodiment, even when the own vehicle location reliability decreases to reliability 1 from reliability 2, the system does not immediately determine that the current location of the own vehicle C is outside the parking place PP and maintains the determination that the own vehicle C is in the parking place PP for a predetermined travelling distance (e.g. N1 meters) or for a predetermines travelling time (e.g. T1 seconds). Similarly, according to the present embodiment, even when the own vehicle location reliability decreases to reliability 0 from reliability 2, the system does not immediately determines that the current location of the own vehicle C is outside the parking place PP and maintains the determination that the own vehicle C is in the parking place PP for a predetermined travelling distance (e.g. N2 meters) or for a predetermines travelling time (e.g. T2 seconds). Here, the above N1, N2, T1 and T2 are set depending on a change in the own vehicle location reliability, where T1>T2 and N1>N2.

FIGS. 1, 4 and 5 illustrates a typical operation example of the on-vehicle system 1 according to the present embodiment. FIG. 1 illustrates a state where the own vehicle C is entering a parking place PP. As shown in FIG. 1, in a front left side and a front right side of the own vehicle C travelling straight, at least 3 parking areas PA are continuously arranged in parallel with each other along a predicted course CP of the own vehicle C. Thus, when the parking area PA and the parked vehicle PV are continuously positioned in parallel for a predetermined number, the parking space PS can be determined. Further, each parking area PA is divided by a lane marker having a clear white line without any blur. Hence, the camera 2 is able to appropriately capture the image of the parking area PA. Further, for the parking area PA, a distance from the predicted course CP is within a predetermined range. Hence, in this case, at a time when the own vehicle C enters the parking place PP, the parking space PS and the parked vehicle PV being parked in the parking space PS are detected with high reliability within a predetermined distance in left and right sides of the own vehicle C. Thus, the own vehicle location reliability is determined as reliability 2. Then, a determination whether the own vehicle location is in the parking place PP is immediately satisfied.

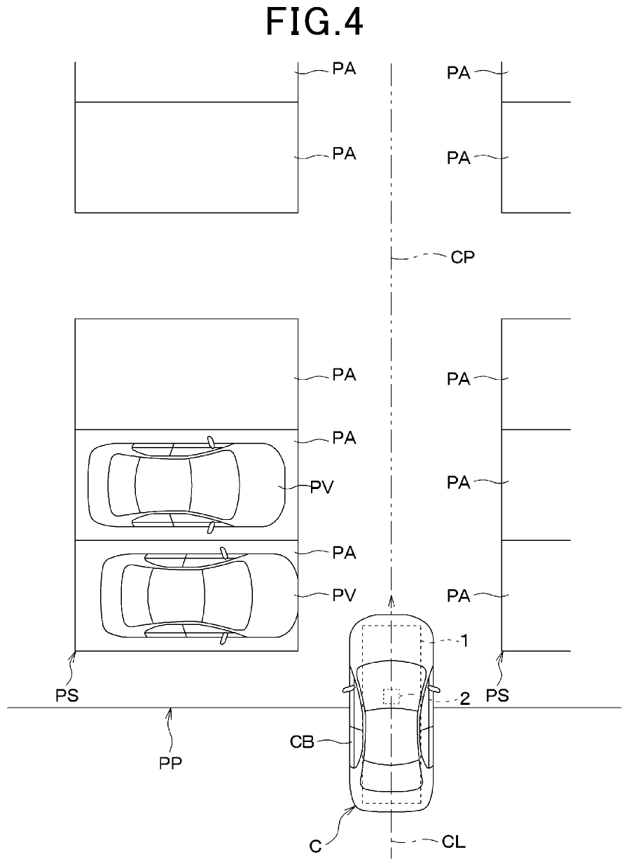

FIG. 4 illustrates a state where the own vehicle C further advances from a state shown in FIG. 1. In this example, it is assumed that a undetected area corresponding to a single parking area PA is present between three consecutive parking areas PA in the front side and the two consecutive parking areas in the far side. In this respect, according the present embodiment, even when a discontinuous area is detected, if any parking area PA or a parked vehicle PV is present in the same direction within a certain distance area, the system determines the areas to be a series of parking space PS. Therefore, in this case, a parking space PS including at least 5 parking areas PA is detected in the from left side and front right side of the own vehicle C. Hence, the own vehicle location reliability is determined as reliability 2, and the determination in which the own vehicle location is in the parking place PP is maintained.

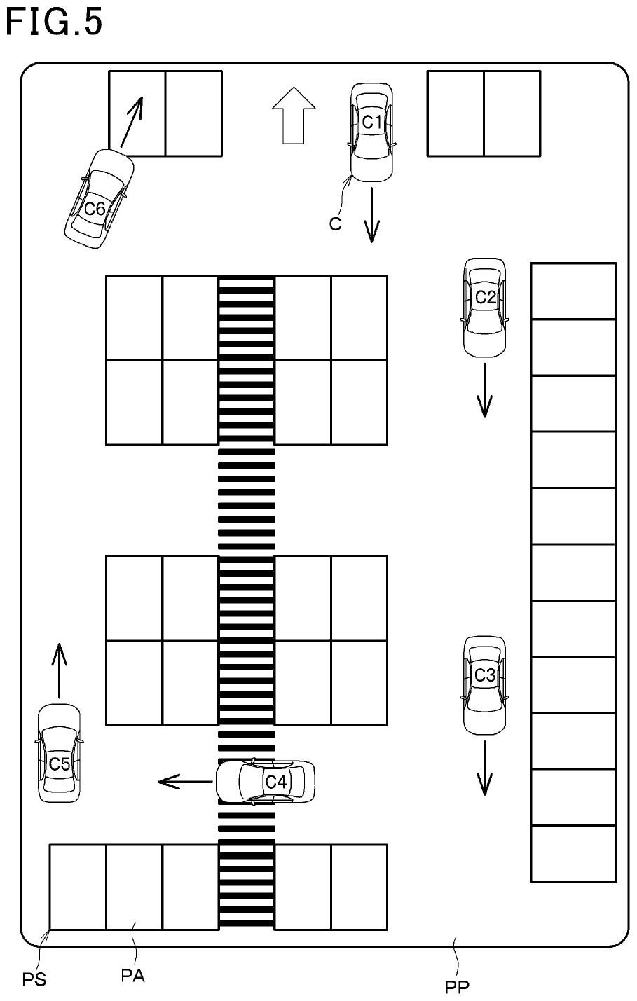

FIG. 5 illustrates a series of movement of the own vehicle C from a time when the own vehicle C enters another parking place PP to when the own vehicle C takes a parking posture after selecting a parking position. In the drawings, each of C1, C2 and the like indicates the own vehicle position at that moment. In the own vehicle position C1, a parking space PS is detected with high reliability within a predetermined distance area in the front side of the own vehicle C, and the own vehicle location reliability is determined to be reliability 2. Thus, the system determines that the own vehicle location is in the parking place PP. At the own vehicle location C2, the parking space PS is detected in the predetermined distance area in the left and right side of the own vehicle C and the own vehicle location reliability is determined to be reliability 2. Thus, the system determines that the own vehicle location is in the parking place PP.

At the own vehicle location C3, a parking space PS is detected with high reliability in a predetermined distance area in the left side of the own vehicle C. On the other hand, a parking space PS is not detected in a predetermined distance area in the right side of the own vehicle C. Hence, the own vehicle location reliability is reliability 1. That is, the own vehicle location reliability decreases to reliability 1 from reliability 2. However, according to the present embodiment, such a decrease in the own vehicle location reliability does not immediately cause a negative determination for a determination whether the own vehicle location is in the parking place PP, but the determination in which the own vehicle location is in the parking place PP is maintained for several tens of meters or for a travelling time corresponding to this distance. Thereafter, at the own vehicle location C4, a parking space PS is detected with high reliability in a predetermined distance area in the left and right sides of the own vehicle C and the own vehicle location reliability is determined to be reliability 2. Thus, the determination in which the own vehicle location is in the parking place PP is maintained.

Next, at the own vehicle location C5, the parking space PS is detected with high reliability within a predetermined distance area in the right side of the own vehicle C. On the other hand, the parking space PS is not detected within the predetermined distance area in the left side of the own vehicle C. Hence, the own vehicle location reliability decreases to reliability 1 from reliability 2. However, similar to the above, the determination in which the own vehicle location is within the parking place PP is maintained for several tens of meters of travelling distance or a travelling time corresponds to this travelling distance. Thereafter, at the own vehicle location C6 at which the own vehicle C takes a parking posture, the parking space PS is not detected with high reliability in the predetermined distance area in the left and right sides of the own vehicle C and the own vehicle location reliability decreases to reliability 0 from reliability 1. However, according to the present embodiment, such a decrease in the own vehicle location reliability does not immediately cause a negative determination for a determination whether the own vehicle location is in the parking place PP, but the determination in which the own vehicle location is in the parking place PP is maintained for several meters or for a travelling time corresponding to this distance.

Thus, even in the case where the determination whether the own vehicle location is in the parking place PP cannot be made according to the above-described conventional art, according to the present embodiment, the own vehicle location can be appropriately determined to be in the parking place PP. Hence, according to the present embodiment, a technique can be provided in which the accuracy for determining whether the current location of the own vehicle C is in the parking place PP is further improved.

(Modifications)

The present disclosure is not limited to the above-described embodiments. Hence, the above-described embodiments may be appropriately modified. Hereinafter, typical modification examples will be described. In the following description of the modification examples, the same reference symbols are applied to mutually the same or equivalent portions. Hence, in the description of the following modification examples, for elements having the same reference symbols as those in the above-described embodiment, explanation for the above-described embodiments may be appropriately applied thereto unless a technical inconsistency or a specific additional explanation is present.

The present disclosure is not limited to the specific configuration described in the above-described embodiments. For example, the camera 2 is not limited to the front camera, but may be an all-around view camera. Further, the number of camera 2 and the mount position of the camera 2 are not specifically limited.

The on-vehicle system 1 may be configured to accomplish at least one of an automatic driving function, a high-level driving assist function, an automatic parking function and a parking assist function. That is, the vehicle control apparatus 5 may have a configuration of ADAS ECU which controls ADAS operation of the own vehicle. ADAS is an abbreviation of advanced driver-assistance system. ECU is an abbreviation of electronic control unit or electronic control unit. In this case, the vehicle control apparatus 5 may be integrated with the travelling control apparatus 7. In other words, the present disclosure is not limited to a PMPD (pedal misapplication prevention device) which prevents a vehicle from suddenly starting in the case where the driver of the own vehicle C erroneously presses an acceleration pedal instead of pressing a brake pedal when braking operation is required in the parking place PP.

All of or a part of the vehicle control apparatus 5 may be provided with a digital circuit configured to perform the above-described operations, for example, an ASIC (application specific integrated circuit) or a FPGA (field programable gate array). Note that both an on-vehicle microcomputer portion and a digital circuit portion may be provided in the vehicle control apparatus 5.

The program according to the present disclosure allowing various operations, procedures or processes to execute can be downloaded or uploaded via V2X (vehicle to X) communication. Alternatively, the program according to the present disclosure can be downloaded or upgraded via a terminal equipment provided in a manufacturing factory, a maintenance factory, an automobile dealer and the like. The program according to the present disclosure may be stored in a memory card, an optical disk, a magnetic disk and the like.

The above-described functional configurations and processing thereof may be accomplished by a dedicated computer constituted of a processor and a memory programmed to execute one or more functions embodied by computer programs. Alternatively, the above-described functional configurations and processing thereof may be accomplished by a dedicated computer provided by a processor configured of one or more dedicated hardware logic circuits. Further, the above-described functional configurations and processing thereof may be accomplished by one or more dedicated computer where a processor and a memory programmed to execute one or more functions, and a processor configured of one or more hardware logic circuits are combined. Furthermore, the computer programs may be stored, as instruction codes executed by the computer, into a computer readable non-transitory tangible recording media. In other words, the above-described functional configurations and processing thereof can be expressed by a computer program including the procedure that accomplishes the above-described functional configurations and processing thereof or a non-transitory tangible recording media that stores the program.

Hence, the image data acquiring unit 501 shown in FIG. 3 and the like is a functional block provided for a convenience to understand the present disclosure. Hence, even when these functional blocks are not actually provided in the vehicle control apparatus 5 as a subroutine or a hardware, as long as functions or processes required in the present disclosure are embodied, the requirement of the present disclosure can be satisfied.

The image data acquiring unit 501 and the parking space detecting unit 502 can be provided in the travelling control apparatus 7 as the ADAS or the ECU. That is, the vehicle control apparatus 5 may be configured to acquire the detection result of the parking space PS and the parked vehicle PV.

The present disclosure is not limited to specific operation modes described in the above-described embodiments. That is, the parking space PS is not limited to a parallel parking, but may be for a diagonally parallel parking, for example. The own vehicle location reliability is not limited to three levels, that is, high, middle and low levels, but may be two levels, that is, high and low levels, or may four or more levels. Further, the reliability is set such that the smaller the N number of reliability N, the higher the reliability is. Alternatively, the reliability may be indicated by symbols including alphabetic characters such as reliability AAA, reliability B+ and reliability C−. Moreover, the reliability may be indicated by consecutive numbers within a predetermined range.

In the case where the own vehicle C performs a turnabout driving in the parking place PP, a state of detecting the parking space PS and the like possibly changes. In this respect, the own vehicle location determination unit 504, when being determined that the own vehicle location is in the parking place PP (affirmative determination) and the shift position is in a reverse position, may maintain this affirmative determination. Specifically, for example, the own vehicle location determination unit 504, when being determined that the own vehicle location is in the parking place PP (affirmative determination) and the shift position is in reverse position, determines that the own vehicle is travelling in the parking place PP and does not count the distance and the time for cancelling the affirmative determination (for example, count operation is stopped or cleared). Thus, mis-determination during the own vehicle travelling in the parking place PP can be appropriately avoided.

Immediately after the ignition switch is operated, because of insufficient acquisitions of the image data by the camera 2, appropriate determination may not be made. Hence, the own vehicle location determination unit 504 may maintain the affirmative determination even when the ignition operation is performed during the affirmative determination in which the own vehicle location is in the parking space PP. Specifically, for example, the own vehicle location determination unit 504 does not clear the count of the distance or the time for cancelling the affirmative determination. Thus, the determination of the own vehicle location is more favorably performed than conventional configuration.

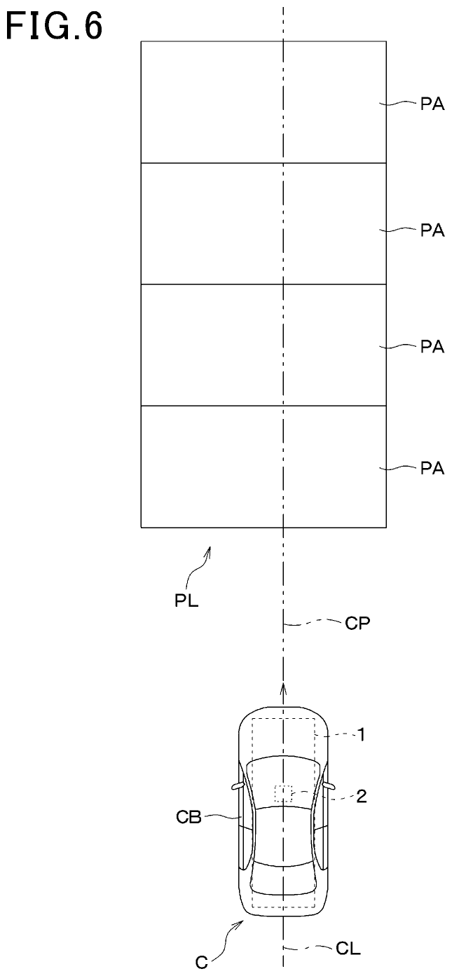

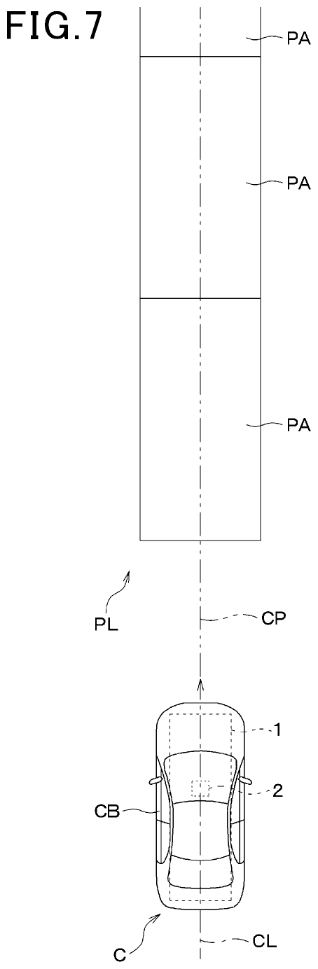

FIG. 6 shows a state where the own vehicle C approaches a parallel-parking type parking strip PL on the road (on-road parking strip PL). FIG. 7 shows a state where the own vehicle C approaches a vertical-parking type on-road parking strip PL. Thus, in the case where a vehicle laterally approaches a parallel parking space or approaches the vertical-parking space, it is possible that the area is a parking strip PL not the parking place PP. In other words, assuming an arrangement direction to be a direction along which a plurality of parking areas PA are consecutively arranged, in the case where a vehicle approaches the parking area PA such that the parking area PA and the own vehicle C are partially overlapped in the arrangement direction, the parking areas may constitute the on-road parking strip PL. Note that ‘the parking area PA and the own vehicle C are partially overlapped in the arrangement direction’ refers to the own vehicle C partially overlaps with an extension space as a virtual space in which the parking area PA is extended in the arrangement direction. That is, at least part of the own vehicle C is located in the above-mentioned extension space. Typically, in this case, as shown in FIG. 6, the parallel parking space overlaps with the predicted course CP, or the vertical-parking space overlaps with the predicted course CP as shown in FIG. 7. In this case, the own vehicle location determination unit 504 may not perform a determination whether the own vehicle location is in the parking place PP. Specifically, the own vehicle location determination unit 504 may be configured to determine that the own vehicle location is not in the parking place PP when the own vehicle C laterally approaches the parallel parking space, or the own vehicle C approaches the vertical-parking space. Thus, erroneous determination where the on-road parking slip PL is determined to be the parking place PP and vice versa can be favorably avoided.

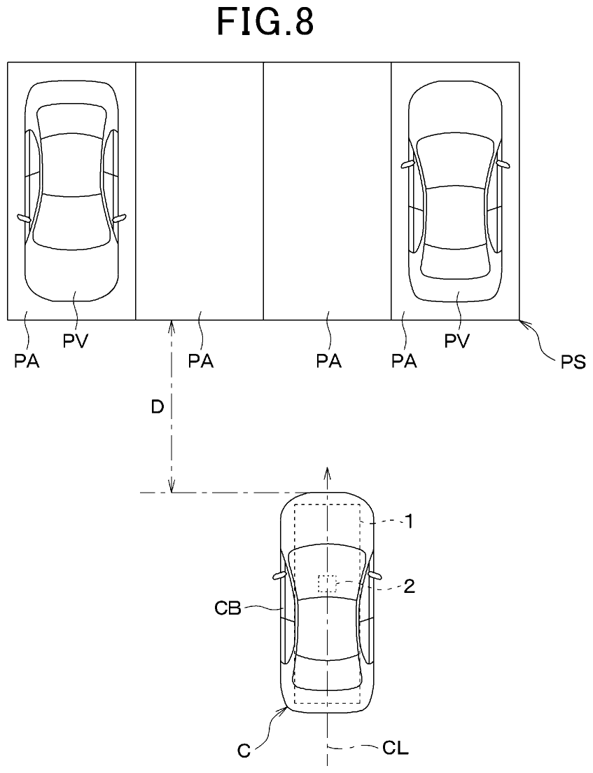

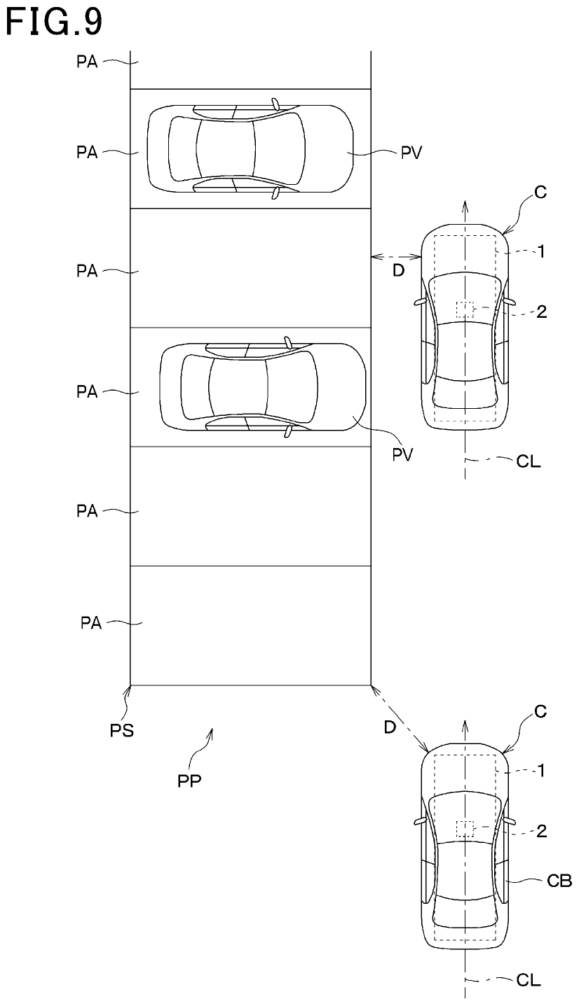

As shown in FIG. 8 and FIG. 9, in the case where the own vehicle C and the parking space PS are closely located, that is, a distance D between the own vehicle C and the parking space PS is short, a sudden start suppression due to erroneous pedal pressing is strongly required. Further, the shorter the distance D, the more increases necessity of executing the sudden start suppression. In this regard, the vehicle control apparatus 5 and/or the travelling control apparatus 7 may change, when the own vehicle location is in the parking place PP, a mode of an acceleration suppression control that suppresses the acceleration of the own vehicle caused by an erroneous acceleration-pedal pressing, depending on the distance D or a converted time value where the distance value D is converted to a time value (e.g. TTC: time to collision). Specifically, for example, the vehicle control apparatus 5 and/or the travelling control apparatus 7 may enable the acceleration suppression control or change a control quantity of the acceleration suppression control.

As is apparent from the description for the configuration and the operations according to the above-described embodiments and modifications, the present disclosure includes the following aspects.

(Aspect 1)

A vehicle control apparatus (5) includes: a reliability determination unit (503) that determines a reliability related to an own vehicle location as a current location of the own vehicle being in a parking place (PP), using a detection result of a parking space (PS) or a parked vehicle (PV) around an own vehicle (C) based on image data around the own vehicle captured by a camera (2); and an own vehicle location determination unit (504) that determines whether the own vehicle location is in the parking space, using a determination result of the reliability determined by the reliability determination unit.

(Aspect 2)

In the vehicle control apparatus according to aspect 1, the reliability determination unit determines the reliability using a relative location of the detected parked vehicle or parking space relative to the own vehicle.

(Aspect 3)

In the vehicle control apparatus according to aspect 1 or 2, the own vehicle location determination unit, when determining as an affirmative determination that the own vehicle location is in the parking place, maintains the affirmative determination even if the reliability decreases while a predetermined affirmative determination maintaining condition is being satisfied.

(Aspect 4)

In the vehicle control apparatus according to aspect 3, the predetermined affirmative determination maintaining condition is a travel distance or an elapsed time.

(Aspect 5)

In the vehicle control apparatus according to aspect 3 or 4,

the own vehicle location determination unit, when determining as the affirmative determination and a shift position is in a reverse position, maintains the affirmative determination.

(Aspect 6)

In the vehicle control apparatus according to any one of aspects 3 to 5, the own vehicle location determination unit maintains the affirmative determination even when an ignition operation is performed during the affirmative determination.

(Aspect 7)

In the vehicle control apparatus according to any one of aspects 1 to 6, the own vehicle location determination unit, when determining as a negative determination that the own vehicle location is not in the parking place, maintains the negative determination even if the reliability increases while a predetermined negative determination maintaining condition is being satisfied.

(Aspect 8)

In the vehicle control apparatus according to aspect 7, the reliability determination unit determines the reliability with a multi-stage level of three or more levels, and the predetermined negative determination maintaining condition is a condition in which the reliability is less than or equal to a predetermined level.

(Aspect 9)

In the vehicle control apparatus according to aspects 1 to 8, the own vehicle location determination unit determines that the own vehicle location is not in the parking place when the own vehicle approaches a vertical-parking space.

(Aspect 10)

In the vehicle control apparatus according to any one of aspects 1 to 9, an acceleration suppression control is provided to suppress an acceleration of the own vehicle caused by an erroneous acceleration-pedal pressing; and when the own vehicle location is in the parking place, a mode of the acceleration suppression control is changed, depending on a distance between the own vehicle and the parking space or a converted time value where a value of the distance is converted to a time value.

(Aspect 11)

A method for controlling a vehicle including steps of: determining a reliability related to an own vehicle location as a current location of an own vehicle (C) being in a parking place (PP), using a detection result of a parking space (PS) or a parked vehicle (PV) around the own vehicle based on image data around the own vehicle captured by a camera (2); and determining whether the own vehicle location is in the parking space, using a determination result of the reliability determined by the reliability determination unit.

(Aspect 12)

In the method for controlling the vehicle according to aspect 11, the reliability is determined using a relative location of the parked vehicle or the parking space relative to the own vehicle.

(Aspect 13)

In the method for controlling the vehicle according to aspect 11 or 12, when determining as an affirmative determination that the own vehicle location is in the parking place, the affirmative determination is maintained even if the reliability decreases while a predetermined affirmative determination maintaining condition is being satisfied.

(Aspect 14)

In the method for controlling the vehicle according to aspect 13, the predetermined affirmative determination maintaining condition is a travel distance or an elapsed time.

(Aspect 15)

In the method for controlling the vehicle according to aspect 13 or 14, when determining as the affirmative determination and a shift position is in a reverse position, the affirmative determination is maintained.

(Aspect 16)

In the method for controlling the vehicle according to any one of aspects 13 to 15, the affirmative determination is maintained even when an ignition operation is performed during the affirmative determination.

(Aspect 17)

In the method for controlling the vehicle according to any one of aspects 1 to 16, when determining as a negative determination that the own vehicle location is not in the parking place, the negative determination is maintained even if the reliability increases while a predetermined negative determination maintaining condition is being satisfied.

(Aspect 18)

In the method for controlling the vehicle according to aspect 17, the reliability is determined with a multi-stage level of three or more levels, and the predetermined negative determination maintaining condition is a condition in which the reliability is less than or equal to a predetermined level.

(Aspect 19)

In the method for controlling the vehicle according to any one of aspects 11 to 18, the own vehicle location is determined to be not in the parking place when the own vehicle approaches a vertical-parking space.

(Aspect 20)

In the method for controlling the vehicle according to any one of aspects 11 to 19, a method of an acceleration suppression control is provided to suppress an acceleration of the own vehicle caused by an erroneous acceleration-pedal pressing; and when the own vehicle location is in the parking place, a mode of the acceleration suppression control is changed, depending on a distance between the own vehicle and the parking space or a converted time value where a value of the distance is converted to a time value.

(Aspect 21)

In a program for controlling a vehicle executed by a vehicle control apparatus (5) to execute processes, the processes including: a reliability determining process that determines a reliability related to an own vehicle location as a current location of the own vehicle being in a parking place (PP), using a detection result of a parking space (PS) or a parked vehicle (PV) around an own vehicle (C) based on image data around the own vehicle captured by a camera (2); and an own vehicle location determination process that determines whether the own vehicle location is in the parking space, using a determination result of the reliability determined by the reliability determination unit.

(Aspect 22)

In the program for controlling the vehicle according to aspect 21, the reliability determining process determines the reliability using a relative location of the detected parked vehicle or parking space relative to the own vehicle.

(Aspect 23)

In the program for controlling the vehicle according to aspect 21 or 22, when determining as an affirmative determination that the own vehicle location is in the parking place, the own vehicle location determination process maintains the affirmative determination even if the reliability decreases while a predetermined affirmative determination maintaining condition is being satisfied.

(Aspect 24)

In the program for controlling the vehicle according to aspect 23, the predetermined affirmative determination maintaining condition is a travel distance or an elapsed time.

(Aspect 25)

In the program for controlling the vehicle according to aspect 23 or 24, when determining as the affirmative determination and a shift position is in a reverse position, the own vehicle location determination process maintains the affirmative determination.

(Aspect 26)

In the program for controlling the vehicle any one of aspects 23 to 25, the own vehicle location determination process maintains the affirmative determination even when an ignition operation is performed during the affirmative determination.

(Aspect 27)

In the program for controlling the vehicle according to any one of aspects 21 to 26, when determining as a negative determination that the own vehicle location is not in the parking place, the own vehicle location determination process maintains the negative determination even if the reliability increases while a predetermined negative determination maintaining condition is being satisfied.

(Aspect 28)

In the program for controlling the vehicle according to aspect 27, the reliability determining process determines with a multi-stage level of three or more levels, and the predetermined negative determination maintaining condition is a condition in which the reliability is less than or equal to a predetermined level.

(Aspect 29)

In the program for controlling the vehicle according to any one of aspects 21 to 28, the own vehicle location determination process determines that the own vehicle location is not in the parking place when the own vehicle approaches a vertical-parking space.

(Aspect 30)

In the program for controlling the vehicle according to any one of aspects 21 to 29, a program for an acceleration suppression control is provided to suppress an acceleration of the own vehicle caused by an erroneous acceleration-pedal pressing; and when the own vehicle location is in the parking place, a mode of the acceleration suppression control is changed, depending on a distance between the own vehicle and the parking space or a converted time value where a value of the distance is converted to a time value.

(Aspect 31)

A vehicle control apparatus (5) is provided with a processor (51) and a memory (52) as a non-transitory substantial recording media storing a computer readable program,

the processor is configured to load and execute the program stored in the memory, thereby executing a reliability determining process that determines a reliability related to an own vehicle location as a current location of the own vehicle being in a parking place (PP), using a detection result of a parking space (PS) or a parked vehicle (PV) around an own vehicle (C) based on image data around the own vehicle captured by a camera (2); and an own vehicle location determination process that determines whether the own vehicle location is in the parking space, using a determination result of the reliability determined by the reliability determination unit.

(Aspect 32)

In the vehicle control apparatus according to aspect 31, the reliability determining process determines the reliability using a relative location of the detected parked vehicle or parking space relative to the own vehicle.

(Aspect 33)

In the vehicle control apparatus according to aspect 31 or 32, when determining as an affirmative determination that the own vehicle location is in the parking place, the own vehicle location determination process maintains the affirmative determination even if the reliability decreases while a predetermined affirmative determination maintaining condition is being satisfied.

(Aspect 34)

In the vehicle control apparatus according to aspect 33, the predetermined affirmative determination maintaining condition is a travel distance or an elapsed time.

(Aspect 35)

In the vehicle control apparatus according to aspect 33 or 34, when determining as the affirmative determination and a shift position is in a reverse position, the own vehicle location determination process maintains the affirmative determination.

(Aspect 36)

In the vehicle control apparatus according to any one of aspects 33 to 35, the own vehicle location determination process maintains the affirmative determination even when an ignition operation is performed during the affirmative determination.

(Aspect 37)

In the vehicle control apparatus according to any one of aspects 31 to 36, when determining as a negative determination that the own vehicle location is not in the parking place, the own vehicle location determination process maintains the negative determination even if the reliability increases while a predetermined negative determination maintaining condition is being satisfied.

(Aspect 38)

In the vehicle control apparatus according to aspect 37, the reliability determining process determines with a multi-stage level of three or more levels, and the predetermined negative determination maintaining condition is a condition in which the reliability is less than or equal to a predetermined level.

(Aspect 39)

In the vehicle control apparatus according to any one of aspects 31 to 38, the own vehicle location determination process determines that the own vehicle location is not in the parking place when the own vehicle approaches a vertical-parking space.

(Aspect 40)

In the vehicle control apparatus according to any one of aspects 31 to 39, a program for an acceleration suppression control is provided to suppress an acceleration of the own vehicle caused by an erroneous acceleration-pedal pressing; and when the own vehicle location is in the parking place, a mode of the acceleration suppression control is changed, depending on a distance between the own vehicle and the parking space or a converted time value where a value of the distance is converted to a time value.

In the above-described embodiments, elements constituting the embodiments are not necessarily required except that elements are clearly specified as necessary or theoretically necessary. Even in the case where numeric values are mentioned in the above-described embodiments, such as the number of constituents, numeric values, quantity, range or the like, it is not limited to the specific values unless it is specified as necessary or theoretically limited to specific numbers. In the case where materials, shapes, directions, positional relationships and the like are mentioned for the constituents in the above-described embodiments, it is not limited to the material, the shapes, directions and positional relationships except that they are clearly specified or theoretically limited to specific material, shapes, directions, positional relationships and the like.

Also, the modification examples are not limited to the above-described examples. Moreover, a plurality of modification examples may be mutually combined. Further, all of or a part of the above-described embodiments and all of or a part of the modification examples may be combined.

### CONCLUSION

The present disclosure provides a technique for improving the accuracy for determining whether the current location of the own vehicle is in a parking space.

The present disclosure provides a vehicle control apparatus (5) including: a reliability determination unit (503) that determines a reliability related to an own vehicle location as a current location of the own vehicle being in a parking place (PP), using a detection result of a parking space (PS) or a parked vehicle (PV) around an own vehicle (C) based on image data around the own vehicle captured by a camera (2); and an own vehicle location determination unit (504) that determines whether the own vehicle location is in the parking space, using a determination result of the reliability determined by the reliability determination unit.

The present disclosure further provides a method for controlling a vehicle including steps or processes: determining a reliability related to an own vehicle location as a current location of an own vehicle (C) being in a parking place (PP), using a detection result of a parking space (PS) or a parked vehicle (PV) around the own vehicle based on image data around the own vehicle captured by a camera (2); and determining whether the own vehicle location is in the parking space, using a determination result of the reliability determined by the reliability determination unit.

Furthermore, the present disclosure provides a program for controlling a vehicle executed by a vehicle control apparatus (5) to execute processes, the processes including: a reliability determining process that determines a reliability related to an own vehicle location as a current location of the own vehicle being in a parking place (PP), using a detection result of a parking space (PS) or a parked vehicle (PV) around an own vehicle (C) based on image data around the own vehicle captured by a camera (2); and an own vehicle location determination process that determines whether the own vehicle location is in the parking space, using a determination result of the reliability determined by the reliability determination unit.

What is claimed is:

1. A vehicle control apparatus comprising:
a reliability determination unit that determines a reliability related to an own vehicle location as a current location of the own vehicle being in a parking place, using a detection result of a parking space or a parked vehicle around an own vehicle based on image data around the own vehicle captured by a camera; and
an own vehicle location determination unit that determines whether the own vehicle location is in the parking place, using a determination result of the reliability determined by the reliability determination unit.

2. The vehicle control apparatus according to claim 1,
wherein
the reliability determination unit determines the reliability using a relative location of the detected parked vehicle or parking space relative to the own vehicle.

3. The vehicle control apparatus according to claim 1,
wherein
the own vehicle location determination unit, when determining as an affirmative determination that the own vehicle location is in the parking place, maintains the affirmative determination even if the reliability decreases while a predetermined affirmative determination maintaining condition is being satisfied.

4. The vehicle control apparatus according to claim 3,
wherein
the predetermined affirmative determination maintaining condition is a travel distance or an elapsed time.

5. The vehicle control apparatus according to claim 3,
wherein
the own vehicle location determination unit, when determining as the affirmative determination and a shift position is in a reverse position, maintains the affirmative determination.

6. The vehicle control apparatus according to claim 3,
wherein
the own vehicle location determination unit maintains the affirmative determination even when an ignition operation is performed during the affirmative determination.

7. The vehicle control apparatus according to claim 1,
wherein
the own vehicle location determination unit, when determining as a negative determination that the own vehicle location is not in the parking place, maintains the negative determination even if the reliability increases while a predetermined negative determination maintaining condition is being satisfied.

8. The vehicle control apparatus according to claim 7,
wherein
the reliability determination unit determines the reliability with a multi-stage level of three or more levels; and
the predetermined negative determination maintaining condition is a condition in which the reliability is less than or equal to a predetermined level.

9. The vehicle control apparatus according to claim 1,
wherein
the own vehicle location determination unit determines that the own vehicle location is not in the parking place when the own vehicle approaches a vertical-parking space.

10. The vehicle control apparatus according to claim 1,
wherein
an acceleration suppression control is provided to suppress an acceleration of the own vehicle caused by an erroneous acceleration-pedal pressing; and
when the own vehicle location is in the parking place, a mode of the acceleration suppression control is changed, depending on a distance between the own vehicle and the parking space or a converted time value where a value of the distance is converted to a time value.

11. A method for controlling a vehicle comprising steps of:
determining a reliability related to an own vehicle location as a current location of an own vehicle being in a parking place, using a detection result of a parking space or a parked vehicle around the own vehicle based on image data around the own vehicle captured by a camera; and
determining whether the own vehicle location is in the parking place, using a determination result of the reliability determined by the reliability determination unit.

12. A program for controlling a vehicle executed by a vehicle control apparatus to execute processes, the processes comprising:
a reliability determining process that determines a reliability related to an own vehicle location as a current location of the own vehicle being in a parking place, using a detection result of a parking space or a parked vehicle around an own vehicle based on image data around the own vehicle captured by a camera; and
an own vehicle location determination process that determines whether the own vehicle location is in the parking place, using a determination result of the reliability determined by the reliability determination unit.
